(19) United States
(12) Patent Application Publication
(10) Pub. No.: US 2012/0103209 A1
(43) Pub. Date: May 3, 2012

(54) Pneumatic high velocity press

(75) Inventor: John Bernard Bornhorst, New Bremen, OH (US)

(73) Assignee: AIRAM PRESS COMPANY LTD.

(21) Appl. No.: 12/925,645

(22) Filed: Oct. 27, 2010

(51) Int. Cl. B30B 15/20

(52) U.S. Cl. 100/269.01

(57) ABSTRACT

A pneumatic press with high slide acceleration and velocity is equipped with an arrangement trigger mechanism for holding the slide, upper die, and punch in place until air pressure force in tons is exerted against slide opposite the upper die and punch. When the trigger mechanism releases the slide, upper die, and punch in a short travel the velocity is very high. This will permit the punch to enter the part material at the strain rate of the material, thus eliminating burrs, reducing fatigue initiation sites on the part material surface where the punch goes through the material. Also will permit forming parts of uniform thickness, impact powder titanium to form sheet, and stamp parts against flat sheet of polyurethane with punch having the shape of the part.

### BACKGROUND OF THE INVENTION

References Cited

| | | |
|---|---|---|
| 7,024,913 | April 2060 | Tang et al. |
| 6,671,938 | January 2004 | McFarland et. al. |
| 5,062,357 | November 1991 | Senior et. al. |
| 4,079,617 | March 1978 | Whiting |
| 4,860,571 | August 1989 | Smedberg et. al. |
| 5,791,241 | August 1998 | Levy |
| 5,182,985 | February 1993 | Gatowski |

1. Field of the Invention

The present invention relates to high velocity pneumatic stamping presses, and more particularly, to an apparatus to permit high velocity slide and die punch. Thus when the die punches go thru the part material being stamped to eliminate burrs and reduce fatigue failures sites when in the past where initiated on the edge of the punch hole during the normal mechanical/hydraulic press stamping operation. Other manufacturing processes such as laser, waterjet, and burnout have the same fatigue failure problems.

Also the high velocity pneumatic press will be able to form and draw different shape parts that require a very uniform material thickness through out the part.

Also the high velocity pneumatic press will be able to impact powder titanium with high velocity and form sheet and parts.

2. Description of the Related Art

Press machines of the type performing stamping and drawing operations employ a conventional construction having a movable slide guided by frame structure including a crown, ram, and a bed. The frame structure supports the slide in a manner enabling reciprocating movement of the slide towards and away from the bed. In one type of a mechanical press, the slide is driven by a crankshaft using a connecting arm assembly coupled to the slide. Press machines are used for a variety of work piece operations and employ a large selection of die sets. According to one type of press machine, a mechanical press includes a crown, slide, and bed having a bolster assembly connected there to with uprights connecting the crown with the bed. The uprights are connected to or integral with the underside of the crown and the upper side of the bed. The slide is positioned between the uprights for reciprocating movement toward and away from the bed. A set of tie rods extends through the crown, uprights, and bed, and is attached at each end with tie rod nuts. Leg members are formed as an extension of bed and are generally mounted, on a shop floor by means of shock absorbing pads.

A press drive motor is attached by means of a belt to a main flywheel. The main flywheel is operative to transmit rotational motion to a crankshaft. The machine also includes a flywheel/clutch brake assembly. The crankshaft is connected to the slide by way of connecting rods, so that the rotary motion of the crankshaft is translated into reciprocating movement of the slide.

A die set includes an upper die member disposed at a free end of the slide, and lower die member disposed at the upper end of the bolster. A workpiece is disposed at the upper side of the lower die member. As the slide reciprocates during its work stroke, the upper die member eventually engages and processes the workpiece in cooperation with the lower die member.

An example of such a mechanical press is disclosed in U.S. Pat. No. 7,024,913 incorporated herein by reference thereto.

One particular type of machine press is a pneumatic press that utilizes pneumatic technology to power the ram, instead of a mechanical means such as discussed above concerning a mechanical press. Tonnage on pneumatic press can be as high as 300 tons or more.

Slide velocity on a mechanical press is at the highest velocity when the slide is in the middle of the stroke and the slowest when it is at bottom and top of stroke. The slide in a mechanical press during the travel down of the slide is increasing in velocity to the middle of the stroke and decreasing in velocity from the middle of the stroke to the bottom of the stroke. The velocity of a mechanical press close to the bottom of the stroke is less than 1 meter per second and on a hydraulic press it is less than that.

What is needed in the art is a method to increase the velocity through the complete stroke and when the upper die with the punch hits the material that is stamped the velocity in much higher than one meter per second.

The pneumatic press with this invention of a high velocity slide, upper die, and punch will produce an edge on the material being stamped that reduces fatigue surface failures on parts that are subject to high cycle rates and high stresses. Presently the part edge when produced by mechanical/hydraulic press, drilling, water jet, laser, torch, and milling will require polishing to reduce the surface marks and burr edges. The special materials such as high strength steels, aluminum, and etc. the burrs and edge fatigue failures occur more than in the past. This will eliminate the requirement for polishing or grinding the punch holes in the material when the punch of a mechanical/hydraulic press went through the material at low velocity. Presently in the aircraft industry they have to polish holes either produced by low velocity punching mechanical/hydraulic press, waterjet, laser, and etc. The auto industry is using more high strength steel, but fatigue imitation sites and burrs in the punch holes have had more failures initiated in the holes where as mild steel had less failures. High strength steel removes weight and absorbs more energy in auto crashes.

What is needed in the art is a method to produce titanium sheet. Present technology requires expensive processes to produce titanium sheet from titanium powder. Titanium in the natural state is powder. If the velocity it high enough when you impact the titanium powder you will produce titanium sheet, and the cost will be considerable less the present method of production. The velocity required to produce titanium sheet is much higher than produced by a mechanical/hydraulic press. The high velocity pneumatic press with this invention will permit forming the titanium part while producing the sheet thus reducing cost more.

What else is needed in the art is a method to produce a part that has uniform material thickness when being drawn, bending, and forming. The pneumatic press with this invention will produce the velocity needed to achieve the strain rate of the material. This is important in the production of fuel cells. The fuel cells need uniform thickness through out the part for peak performance, and are used in the auto industry.

### SUMMARY OF THE INVENTION

According to the present invention there is provided an apparatus for use in a pneumatic press to create the slide acceleration and velocity required. The apparatus employs in one form, a method of having air high pressure 3 tons and higher in the actuator on top of the slide before the slide starts to travel down or out. The present pneumatic presses the actuator above the slide has no air pressure zero tons and will not increase until a pneumatic valve is shifted from a closed position to an open position. Thus air will only enter the actuator only as quick as the spool in the air valve moves and in testing the velocity is limited by how fast you can bring the actuator up to high pressure. The slide is usually extended out all the way before the spool in the valve is completely open. Thus the air pressure in the actuator is pounds instead of tons and that is needed to overcome the springs, thus no tons of force only pounds on the top of the slide, the actuator does not have air pressure in force tons until the slide has completed the travel and than the air pressure will increased in tons to the maximum gauge air pressure when slide and punch impacts the material or meets a resistance. The equation where force equals mass time's acceleration. Newton's second law states. Change of motion is proportional to the force applied/

This if you increase the force the velocity will increase. The present state of the art has no air pressure tonnage against the top of the slide until the spool in the main valve start to shift and let the air pressure into the actuator and the air pressure in the actuator only increases as fast as the spools travels open.

This invention has the air pressure in the actuator on top of the slide at the maximum pressure gauge setting and thus we will have tonnage from 3 to 300 tons or more on top of the slide, the mechanical trip mechanism will release the slide with the air tonnage from 3 to 300 tons or more against the top of the slide, thus when the slide starts to travel down the force in tons against the top of the slide is at preset press tonnage or what ever is set on the pressure gauge regulator and not controlled by the valve or other air restrictions entering the actuator. The velocity of the slide increasing at a much higher rate than the present state of the art. Since the punch, upper die, are attached to the slide the punch will be at the same velocity as the slide. This invention will mechanically release the slide 3 to 300 tons or more against the top of the slide. And presently the pneumatic press would have no air pressure thus no tonnage above the slide until a mechanism would increase the air pressure and the slide would move as soon as the air pressure force would over come the springs that hold the slide up. As the air pressure increases in the actuator the slide moves very slow in comparison to the mechanism in this invention. This invention will have several tons of force against the top of the slide before the slide is released to start extending out, thus punch entering material at a very high velocity 3 to 15 meters per second and can be a lot higher than 15 meters per second.

### BRIEF DESCRIPTION OF THE DRAWINGS

The above mentioned and other features and advantages of this invention, and the manner of attaining them, will become more apparent and the invention will be better understood by reference to the following description of at least one embodiment of the invention taken in conjunction with the accompanying drawings, wherein:

FIG. 1 is a side elevation view of a pneumatic press machine utilizing the present invention. Incorporating a high velocity slide trip mechanism with the trip mechanism extended thus preventing any slide movement and no air pressure on the top of the slide. Now the press is ready for complete cycle of operation.

FIG. 2 is a side elevation view of a pneumatic press machine incorporating a high velocity slide trip mechanism extended preventing slide movement and with maximum air gauge pressure at 2 to 300 toms on the top of the slide.

FIG. 3 is a side elevation view of a pneumatic press machine incorporating a high velocity slide trip mechanism retracted that has released the slide with maximum air gauge pressure at 2 to 300 tons on the top of the slide in the extended out position with the punch going thru the material at a very high velocity.

FIG. 4 is a side elevation view of a pneumatic press machine incorporating a high velocity slide trip mechanism with the air pressure removed thus no tonnage on the top of the slide and the springs starting to bring slide back to the retracted position.

FIG. 5 is a side elevation view of a pneumatic press machine incorporating a high velocity slide trip mechanism with air pressure removed thus no tonnage on top of the slide and the springs have the slide in the retracted position before the trip mechanism is extended.

FIG. 6 is a view of the results of a punch going thru part material at low velocity, thus burr and fatigue failure sites on the material hole edge,

FIG. 7 is a view of the results of a punch going thru part material at high velocity with tons of force on the top of the slide, and results on part material edge show no burrs and reduce fatigue failure sites.

FIG. 8 is a view of the form punch before impacting the part material with stationary polyurethane/plastic fastened to the bed and supporting the part material.

FIG. 9 is a view of the form punch impacting the part material.

FIG. 10 is a view of the form punch traveling away from the final form part, and polyurethane/plastic returned to normal flat shape.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE INVENTION

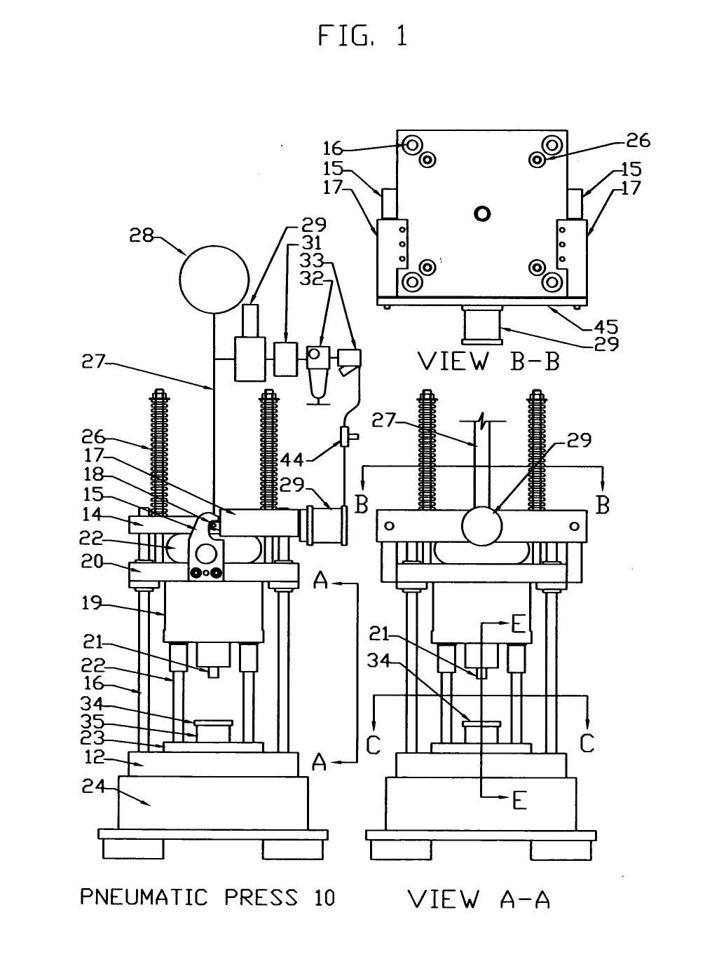

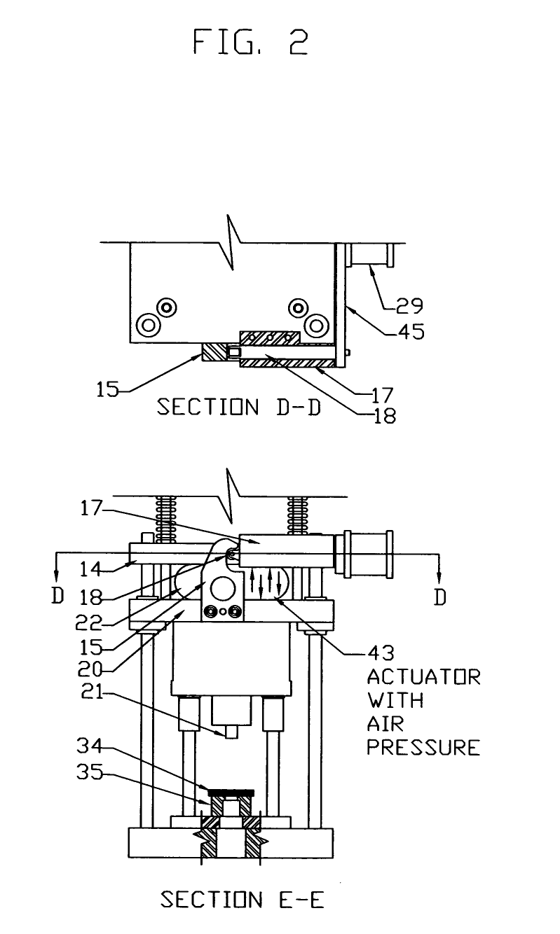

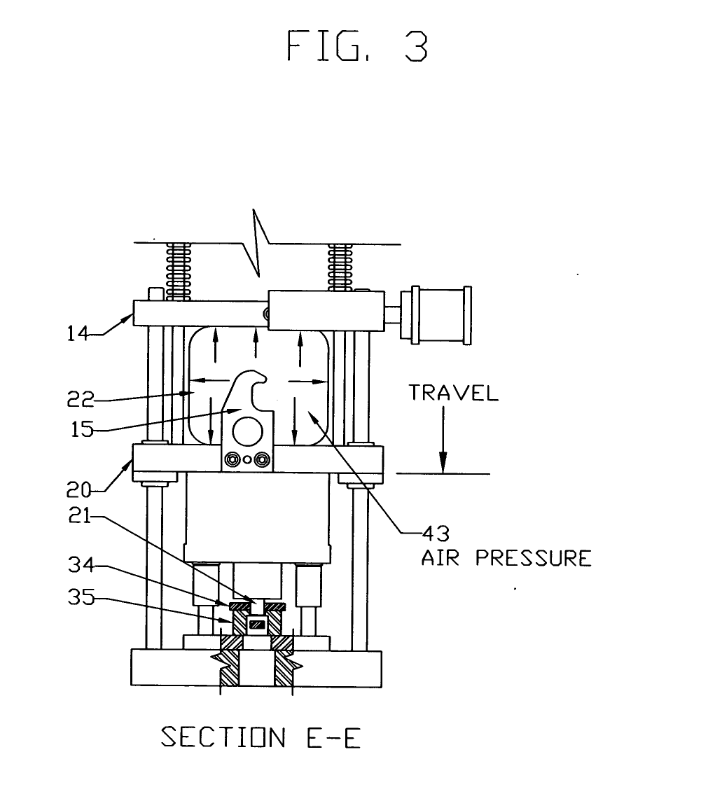

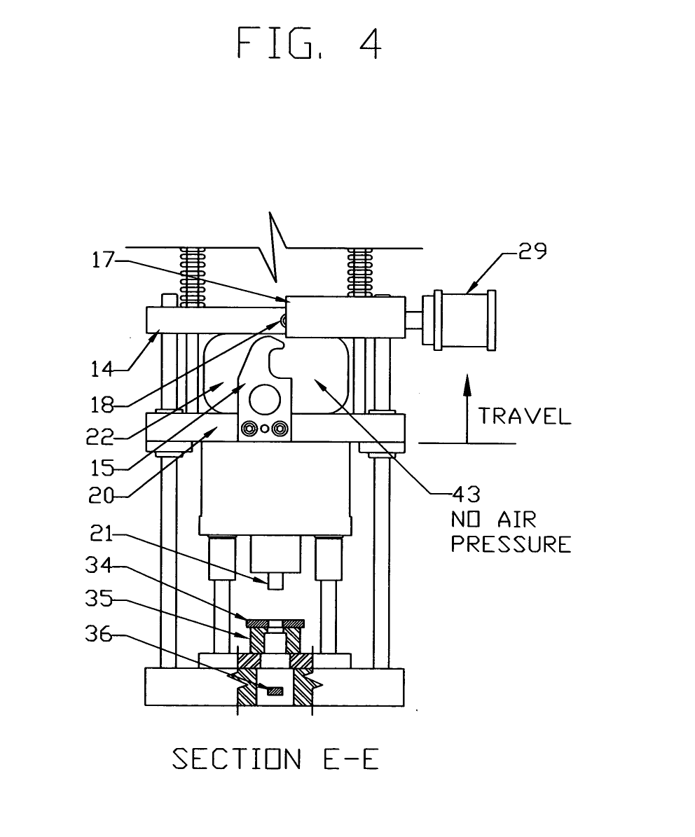

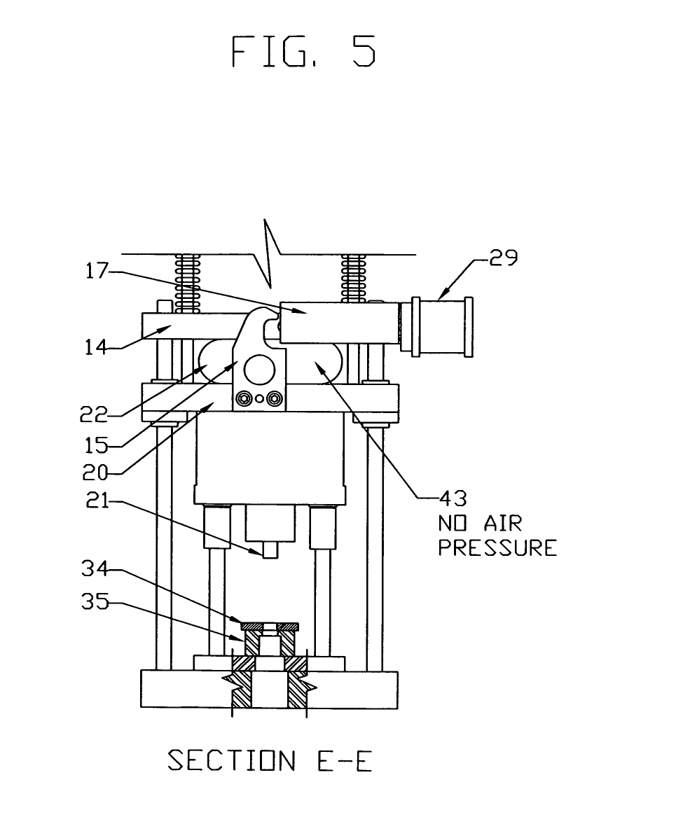

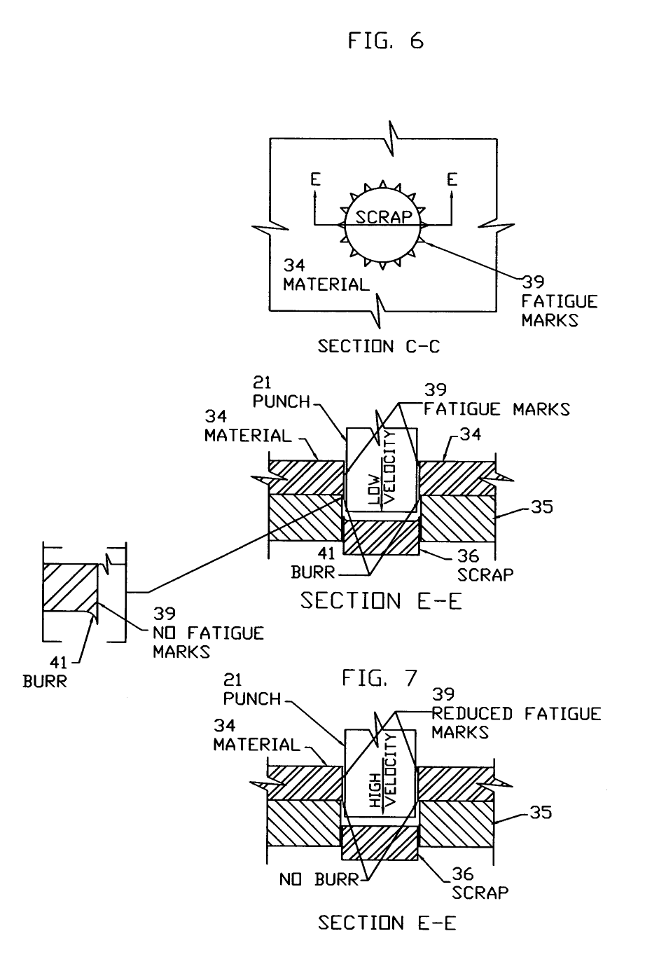

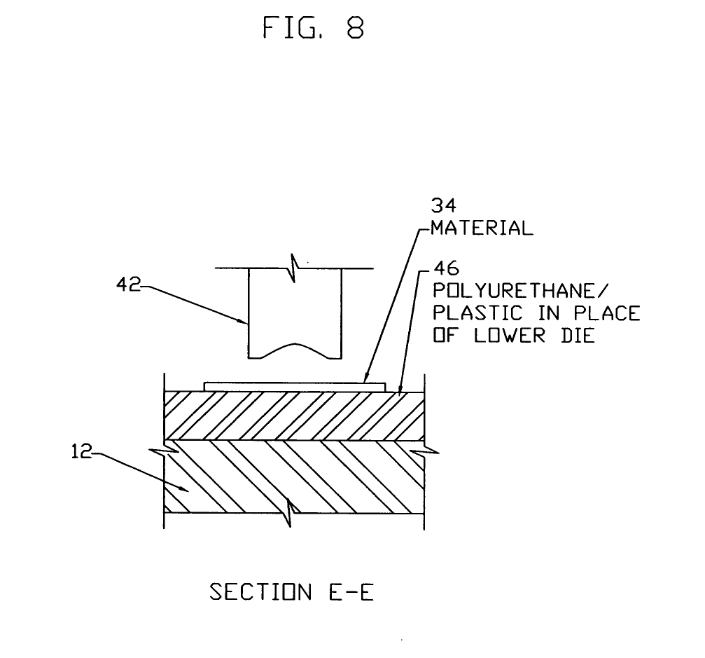

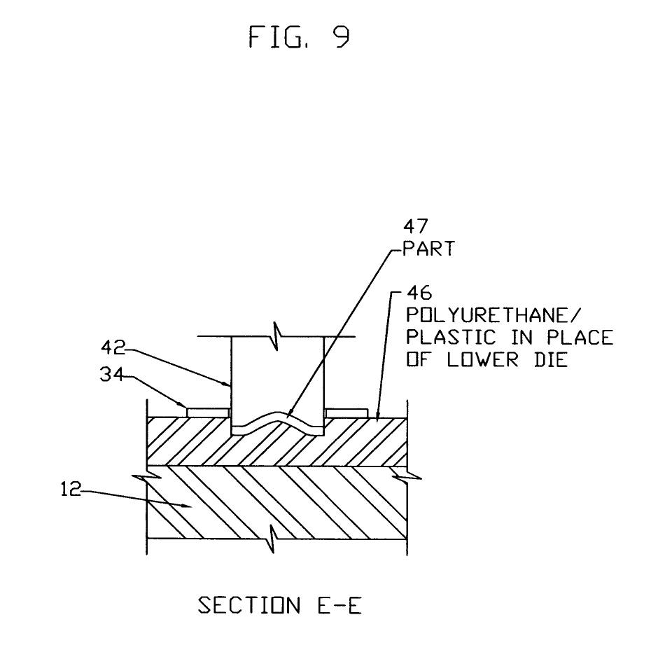

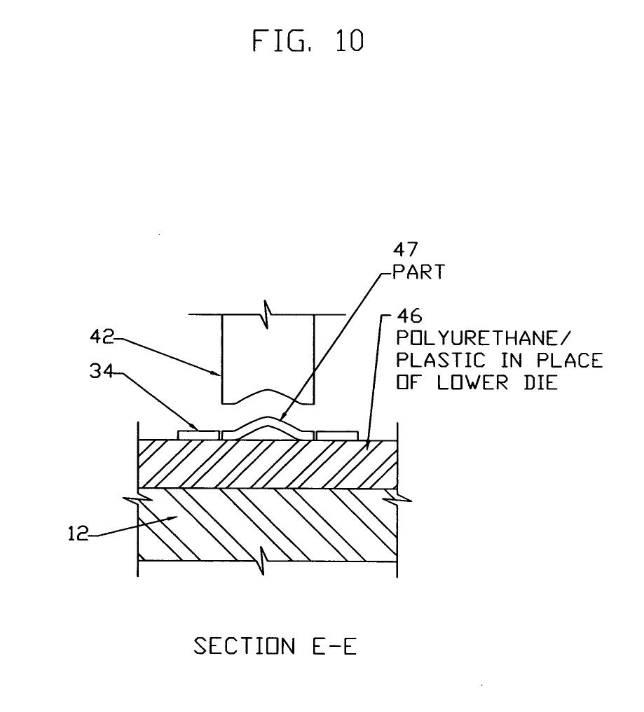

Referring generally to FIGS. 1 thru 10, there is shown a pneumatic press 10 according to one form of the present invention. Press 10 includes a first selectively pressure stamping actuator 22 to facilitate cyclic reciprocation of slide 20 according to a normal working operation, and a press base 24.

Press 10 includes a bed 12 and crown 14 supported by tie rods 16. Tie rods 16, which extend through both bed 12 and crown 14. The press slide 20 is located between bed 12 and crown 14 reciprocation there between. A set of dies upper die 19 and lower die 23 are disposed on slide 20 and bed 12 in opposing relationship to one another, according to conventional arrangements known to those skilled in the art.

A hook member 15 fastened to slide 20 and held in place by plunger 18 and plunger 18 guided by holder 17 mounted to the crown 14. The plunger 18 is activated by cylinder 29. The upper die 19 is fastened to the bottom of the slide 20. The punch 21 is fastened to the upper die 19. The upper die 19 is guided with the four die guide posts 22, which are fastened to the lower die base 23. The lower die 23 has the receiver holder 35 with the hole for the punch 21 to enter. The punch 21 is fastened to the upper die 19. The tie rods 16 guide the slide and fastened to the bed 12 and crown 14. The bed 12 is fastened to the base 24 and the base 24 set on the floor and. supports the pneumatic press 10.

The actuator 22 when pressurized with air will have a force 43 will push the slide 20 down and created the press 10 tonnage. The springs 26 hold the slide 20 up and return the slide 20 back to the retracted position. The actuator 22 when pressurized with high air pressure will have force 43 against the top of the slide 20 with 2 tons and higher than the springs 26 and cause the slide 20 to extend out or away from the crown 14. The air pressure to the actuator 22 will come from the air tank 28 thru pipe 27 and the air tank 28 will receive air through valve 29. The valve 29 air will receive air from the filter 31, regulator 32, and shutoff dump valve 33. The air to the shutoff dump valve 33 will be supplied from the plant air supply or air compressor.

When the high velocity punch 21 goes thru the material 34 it will have less fatigue 39 initiation sites on the material 34 and as the punch 21 exits the material 34 the material 34 will have no burrs 41

When the punch 21 is replaced with a form die 42 and the velocity is high enough to be in the strain rate of the material 34 the sides, top, and other parts of the stamped part 47 will have the same uniform thickness. Also using form die 42 and material 34 with a flat sheet of polyurethane/plastic 46 fastened to the bed 12 and the form die 42 will impact the material 34 and the material 34 will take the shape of the form die 42 when pushed against the flat sheet of polyurethane/plastic 46 if the form die 42 has enough velocity to be in the strain rate of the material 34 it will produce a part 47 of uniform thickness. This invention would reduce die cost and require no die guide posts 22 and lower die 23.

The following is a description of one complete cycle of the pneumatic high velocity press. The valve 29 is energized permitting high pressure air into the tank 28 and high pressure air into the pipe 27, and actuator 22. This will have high air pressure 2 tons and higher will create a force 43 against the slide 20. The air valve 44 is energized permitting air flow to cylinder 29. Cylinder 29 is fastened to bracket 45 and bracket 45 is fastened to plunger 18 and plunger 18 will retract and releasing hook 15 which is fastened to slide 20. Also upper die 19 and punch 21 are fastened to slide 20. The high air pressure will have a force 43 of 2 tons and more thus accelerate the slide 20 at a very high acceleration thus increase velocity of the punch 21, slide 20, and upper die 19 very rapidly through the complete travel of the slide 20. In the pry art of a standard pneumatic press the slide20 would have no air pressure force 43 on the top of the slide thus start down slow as the air is supplied to the actuator 22 creating a very small force 43 against the top of the slide 20 and the slide 20 would only travel as fast as the air pressure force 43 is increased, and that would depend on the shifting speed of the valve 29 spool and/or orifice size in the valve 29. The pneumatic press tonnage would only have tonnage force 43 when the punch 21 comes in contact with the material 34 and tonnage force 43 will increase until the punch 21 tonnage is higher than the material 34 shear strength. The punch 21 velocity in that situation is low less than 2 meters per second. The fatigue 39 failure sites, and burrs 41 will be present on the material 34.

The pneumatic press 10 with this invention the slide 20 will increase in velocity until the punch 21 hits the material 34 or impacts the material 34. The punch 21 will drive the material 34 through opening in the lower die 35, or impact the material 34.

The material 34 that the high velocity punch 21 has removed from the material 34 is now scrap 36. The punch 21 velocity going thru the material 34 is at the strain rate of the material 34 thus not causing a burr 41 leaving the material 34, and reducing fatigue 39 failure sites along the sides of the material 34 caused by the punch 21 on the material 34 and scrap 36 being removed.

The punch 21, upper die 19, and the slide 20 will come to a stop after the punch 21 is thru the material 34. The valve 29 will de-energize releasing the high pressure air from the tank 28, actuator 22, thus reducing force 43 to zero, and now the springs 26 can bring the slide 20, upper die 19, and punch 21 back to the retracted position as the air pressure is released to atmosphere by the valve 29 thus no force 43 on the top of the slide 20. The slide 20 is back to the retracted position. Valve 44 is shifted and air pressure from valve 44 into cylinder 29 and cylinder 29 is fastened to 45 and 45 is fastened to plunger 18 and the plunger 18 is extended and now the hook 25 which is fastened to the slide 20 cannot travel down until the plunger 18 is retracted. The complete cycle now can be repeated as many times as necessary.

What is claimed is:

1. A pneumatic press having a crown, a bed, a slide reciprocatable between the crown and the bed. To produce the high impact punch velocity when contacting the product material, a mechanism will hold the slide with the punch until the air pressure is increased from zero to line gage pressure in the air tube or actuator and thus tons of force pushing on the slide before release of the slide. Than the mechanism will release the slide with tons of force pushing against the slide with the punch attached to the slide. This will permit very high velocity slide with die and punch and in very short amount of travel the punch will enter the material at a very high acceleration and velocity and achieve the strain rate of the material thus eliminating the burrs and reducing fatigue failure sites on the material the punch is going thru. In the field of the art this is known as material strain rate.

2. The very high velocity slide, and punch of the pneumatic press will permit powder titanium when impacted with a high velocity to form flat sheet. In nature form of titanium is powder.

3. The very high velocity of the slide and forming punch of the pneumatic press will permit forming product parts of uniform thickness when drawing and forming product parts for certain applications such as fuel cells. When the punch velocity is in the strain rate of the material the product part will have uniform thickness everywhere and some product materials will only need a stationary flat sheet of polyurethane/plastic on the opposite side of the form die.
